(19) United States
(12) Patent Application Publication
(10) Pub. No.: US 2025/0329957 A1
(43) Pub. Date: Oct. 23, 2025

(54) ROTATABLE ELECTRICAL DEVICE

(71) Applicant: ABB SCHWEIZ AG, Baden (CH)

(72) Inventors: Marcus Jones, Germantown, TN (US); Rick Kukucka, Ann Arbor, MI (US)

(21) Appl. No.: 18/643,211

(22) Filed: Apr. 23, 2024

(51) Int. Cl. H01R 13/44; H01R 13/52; H01R 13/713; H01R 13/74; H01R 27/00

(52) U.S. Cl. CPC H01R 13/44; H01R 13/74; H01R 13/5202; H01R 13/7135; H01R 27/00

(57) ABSTRACT

A plug assembly can include a housing configured to be installed to a first surface of a body. A plug assembly can include a power outlet configured to receive an electrical plug, wherein the power outlet is configured to be removably stored within the housing, wherein in a stored configuration, the power outlet is at least partially stored within the housing, wherein in a deployed configuration, the power outlet is exposed from the housing and extends beyond a second surface of the body, wherein the power outlet is configured to be rotatable about a longitudinal axis of the housing when the power outlet is in the deployed configuration.

### FIELD

This disclosure relates generally to plug assemblies. More particularly, this disclosure relates to plug assemblies configured to be stowable under a surface such as, but not limited to a countertop or other furniture surface.

### BACKGROUND

Horizontal surfaces, such as a kitchen countertop, may not be suitable for an electrical plug outlet. In some such cases, the electrical plug outlet may be disposed on a vertical side surface below the countertop surface instead. However, such electrical plug outlets may be inadvertently accessible (e.g., by a child) and can result in accidentally pulling a powered appliance down from the horizontal surface, which can result in physical injuries.

### SUMMARY

In some embodiments, a plug assembly includes a housing configured to be installed to a first surface of a body and a power outlet configured to receive an electrical plug. In some embodiments, the power outlet is configured to be removably stored within the housing. In some embodiments, in a stored configuration, the power outlet is at least partially stored within the housing. In some embodiments, in a deployed configuration, the power outlet is exposed from the housing and extends beyond a second surface of the body. In some embodiments, the power outlet is configured to be rotatable about a longitudinal axis of the housing when the power outlet is in the deployed configuration.

In some embodiments, in the stored configuration, the power outlet is configured to be electrically isolated from a power source.

In some embodiments, the power outlet includes a ground fault circuit interrupter.

In some embodiments, the power outlet includes one or more low voltage accessory inputs configured to receive a low voltage plug.

In some embodiments, the housing is configured to be sealed to prevent ingress of water.

In some embodiments, the first surface of the body is an underside of the body.

In some embodiments, the first surface is a countertop surface.

In some embodiments, the first surface is a desktop surface, a tabletop surface, or a furniture surface.

In some embodiments, in the deployed configuration, the power outlet is configured to be disposed above the second surface of the body.

In some embodiments, the power outlet includes a three-prong opening.

In some embodiments, the power outlet includes a universal serial bus (USB) port.

In some embodiments, the power outlet is configured to be rotatable by less than 360° and the power outlet is configured to be rotatable by at least 30°.

In some embodiments, the plug assembly includes a first ring and a second ring. In some embodiments, the first ring includes a protrusion. In some embodiments, the second ring has a channel. In some embodiments, the channel includes a first end and a second end. In some embodiments, the first end and the second end limit an amount of rotation of the power outlet.

In some embodiments, the first ring or the second ring is configured to provide tactical feedback during rotation in response to a set amount of rotation.

In some embodiments, a plug assembly includes a housing configured to be installed to a bottom surface of a countertop and a power outlet configured to receive an electrical plug. In some embodiments, the power outlet is configured to be removably stored within the housing. In some embodiments, in a stored configuration, the power outlet is at least partially stored within the housing. In some embodiments, in a deployed configuration, the power outlet is exposed from the housing and extends beyond a top surface of the countertop. In some embodiments, the power outlet is configured to be rotatable about a longitudinal axis of the housing when the power outlet is in the deployed configuration.

In some embodiments, the power outlet includes a ground fault circuit interrupter.

In some embodiments, the power outlet includes one or more low voltage accessory inputs configured to receive a low voltage plug.

In some embodiments, the plug assembly includes a cap. In some embodiments, the cap includes a wireless power charger configured to inductively charge an electronic device placed on the cap.

In some embodiments, the power outlet is configured to be rotatable by less than 360° and the power outlet is configured to be rotatable by at least 30°.

In some embodiments, the plug assembly includes a first ring and a second ring. In some embodiments, the first ring includes a protrusion. In some embodiments, the second ring has a channel. In some embodiments, the channel includes a first end and a second end. In some embodiments, the first end and the second end limit an amount of rotation of the power outlet.

### BRIEF DESCRIPTION OF THE DRAWINGS

References are made to the accompanying drawings that form a part of this disclosure and that illustrate embodiments in which the systems and methods described in this Specification can be practiced.

FIG. 1 is a schematic diagram of a body such as, but not limited to, a kitchen cabinet or the like, according to some embodiments.

FIG. 2 is a schematic diagram of the body of FIG. 1, according to some embodiments.

FIG. 3 shows a top view of the plug assembly of FIG. 1 and FIG. 2 with the cap removed, according to some embodiments.

Like reference numbers represent the same or similar parts throughout.

### DETAILED DESCRIPTION

Horizontal surfaces, such as a kitchen countertop, may not be suitable for an electrical plug outlet. In some such cases, the electrical plug outlet may be disposed on a vertical side surface instead. However, such electrical plug outlets may be inadvertently accessible (e.g., by a child or inadvertent contact) and can result in accidentally pulling a powered appliance down from the horizontal surface, which can result in physical injuries.

Embodiments of this disclosure relate to a rotatable countertop popup plug assembly that enables a user to reorient the electrical plug outlets. In some embodiments, the user may be able to rotate the plug assembly to a direction that is most useful for the user.

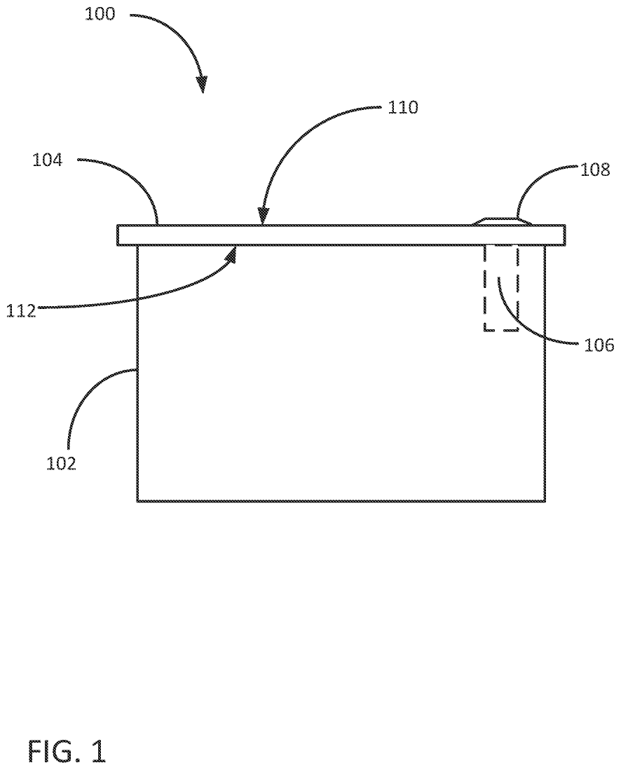

FIG. 1 is a schematic diagram of a body 100 such as, but not limited to, a kitchen cabinet or the like, according to some embodiments. It is to be appreciated that the use of a kitchen cabinet is an example for simplicity of this Specification, but that other types of bodies including a horizontal surface are contemplated within the scope of this disclosure. For example, other types of bodies include furniture items such as desks having a desktop surface; tables having a tabletop surface; other furniture pieces such as, but not limited to, workbenches having a workbench surface; end tables having a tabletop surface; outdoor decks or terraces; other similar items in which it may be useful to have power access; or the like.

The body 100 includes a housing 102 and a countertop 104. As illustrated in dashed lines, the body 100 also includes a plug assembly 106. In the illustrated embodiment, the plug assembly 106 is in a stored configuration. In the stored configuration, the plug assembly 106 can be disposed under a surface 110 of the countertop 104. As illustrated, a cap 108 may protrude above the surface 110 of the countertop 104. In some embodiments, the cap 108 can be formed of a similar material to the countertop 104 so that the cap 108 blends in with the countertop 104. In some embodiments, the material of the cap 108 can be different than the material of the countertop 104. In some embodiments, the surface 110 can be referred to as the topside surface of the countertop 104. In some embodiments, the plug assembly 106 can be secured to a surface 112 of the countertop. The surface 112 is opposite the surface 110. In some embodiments, the surface 112 can be referred to as the bottom side surface of the countertop 104. In some embodiments, the surface 110 and the surface 112 can be major surfaces that are planar. In some embodiments, the surface 110 and the surface 112 can be parallel to a surface of the ground on which the housing 102 is located.

In some embodiments, when the plug assembly 106 is in the stored configuration, the plug assembly 106 may be disconnected from a power source (i.e., electrically isolated from the power source). In some embodiments, the power source can be another electrical outlet or an electrical panel for the building in which the body 100 is located.

In some embodiments, a pneumatic spring or other device can be included in the plug assembly 106 so that the user does not have to pull on the plug assembly 106 to move from the stored configuration to the deployed configuration. In some embodiments, the pneumatic spring or other device can be used to provide a portion of the movement, then the user can pull the cap 108 to completely extend the plug assembly 106.

In some embodiments, a housing 130 of the plug assembly 106 can be installed to the countertop 104. For example, the housing 130 may be installed to the surface 112 of the countertop 104.

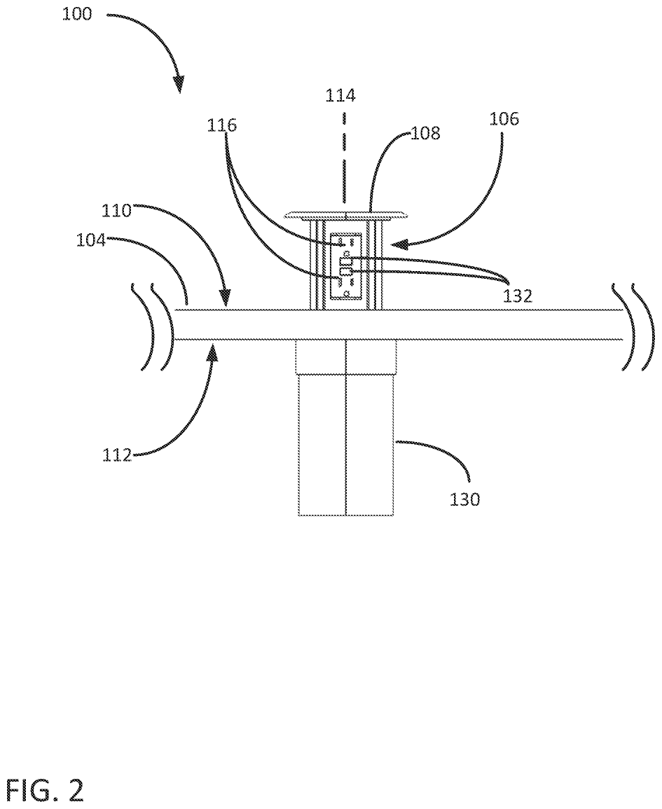

FIG. 2 is a schematic diagram of the body 100, according to some embodiments. For purposes of this disclosure, the housing 102 has been removed from the illustration. Additionally, only a portion of the countertop 104 is illustrated.

As illustrated, the plug assembly 106 is in a deployed configuration in which the plug assembly 106 is raised above the surface 110 of the countertop 104. In some embodiments, the plug assembly 106 is rotatable about its longitudinal axis 114. In some embodiments, an amount of rotation may be limited so that the electrical wiring to one or more power outlets 116 does not twist. In some embodiments, an amount of rotation may be limited to less than 360°. In some embodiments, an amount of rotation may be limited to less than 270°. In some embodiments, an amount of rotation may be limited to less than 180°. In some embodiments, an amount of rotation may be limited to less than 90°. In some embodiments, an amount of rotation may be at least 30°. In some embodiments, an amount of rotation may be at least 60°. In some embodiments, an amount of rotation may be at least 90°. In some embodiments, an amount of rotation may be at least 120°. In some embodiments, an amount of rotation may be at least 150°. In some embodiments, an amount of rotation may be at least 180°.

In some embodiments, the one or more power outlets 116 can include a ground fault circuit interrupter (GFCI). In some embodiments, the one or more power outlets 116 include three-prong openings. In some embodiments, the plug assembly 106 can include the one or more power outlets 116 along with one or more accessories. For example, in some embodiments, the plug assembly 106 can include one or more low voltage accessory inputs 132 configured to receive a low voltage plug. In some embodiments, a low voltage accessory can include, but is not limited to, a universal serial bus (USB) connection or the like. In some embodiments, the low voltage accessory inputs 132 can include an output such as, but not limited to, a light to provide, for example, lighting in a dark room (e.g., a nightlight).

In some embodiments, the one or more low voltage accessory inputs 132 can be a USB input that can be used to, for example, charge an electronic device. The one or more low voltage accessory inputs 132 can be different types of USB inputs (e.g., USB-A, USB-C, Micro-USB, or the like).

In some embodiments, the plug assembly 106 can be made of a combination of materials including both metallic and non-metallic materials.

In some embodiments, the cap 108 can include a wireless charging pad (i.e., a wireless power charger providing inductive charging of electronic devices) so that, for example, a user can place an electronic device on top of the cap 108 to charge the electronic device. In some embodiments, all or a portion of the cap 108 can include a light that is configured to be enabled when in the deployed configuration.

In some embodiments, the cap 108 can include a gasket or seal so that when in the stored configuration water or other liquids are unable to enter the plug assembly 106. In some embodiments, the plug assembly 106 can also include a ring or other surround that ensure that water cannot enter the plug assembly 106 when in the deployed configuration.

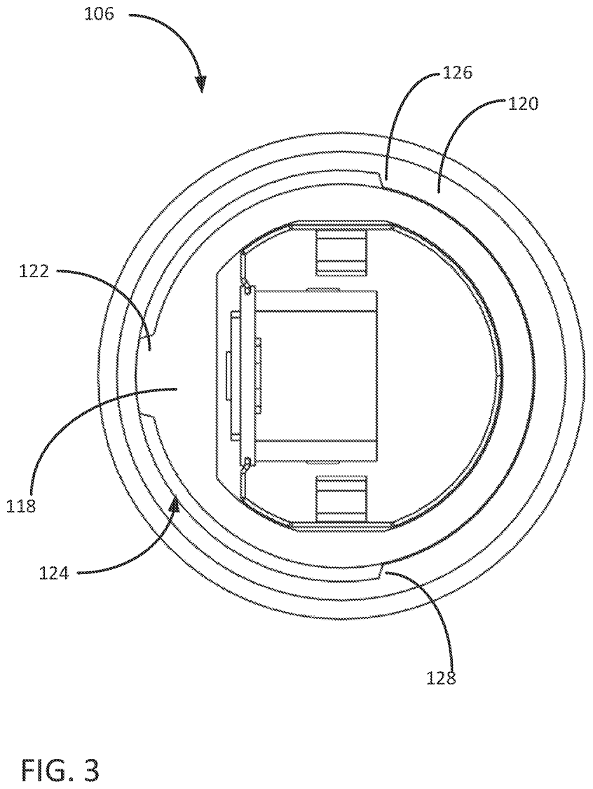

FIG. 3 shows a top view of the plug assembly 106 with the cap 108 removed, according to some embodiments. The cap 108 is removed for simplicity of this Specification and to enable visibility of certain features that will be described in additional detail with respect to FIG. 3.

The rotational axis of the plug assembly 106 is into/out from the page so that the plug assembly 106 is capable of rotating in a counterclockwise direction or a clockwise direction with respect to the page. As shown in FIG. 3, the plug assembly 106 includes a first ring 118 and a second ring 120. The first ring 118 is configured to have a smaller diameter than the second ring 120 so that the first ring 118 is within the second ring 120. As a result, the first ring 118 and the second ring 120 are concentrically arranged.

In the illustrated embodiment, the first ring 118 includes a protrusion 122. The second ring 120 includes a corresponding channel 124 through which the protrusion 122 is able to rotate. When the protrusion 122 abuts an end 126 or end 128 of the corresponding channel 124, the rotation of the plug assembly 106 is stopped. As a result, the end 126 and the end 128 serve to limit an amount of rotation of the plug assembly 106. Accordingly, the second ring 120 including the end 126 and the end 128 are designed to provide a selected amount of rotation for the plug assembly 106.

In some embodiments, an amount of rotation may be limited to less than 360°. In some embodiments, an amount of rotation may be limited to less than 270°. In some embodiments, an amount of rotation may be limited to less than 180°. In some embodiments, an amount of rotation may be limited to less than 90°. In some embodiments, an amount of rotation may be at least 30°. In some embodiments, an amount of rotation may be at least 60°. In some embodiments, an amount of rotation may be at least 90°. In some embodiments, an amount of rotation may be at least 120°. In some embodiments, an amount of rotation may be at least 150°. In some embodiments, an amount of rotation may be at least 180°.

It is to be appreciated that the assembly including the first ring 118 and the second ring 120 are an example and that other manners for limiting the rotation may be possible. For example, in some embodiments, the first ring 118 can include a protrusion and the second ring 120 can include one or more detents into which the protrusion can be received to periodically stop rotation of the plug assembly 106. In some embodiments, the first ring 118 can include the channel and the second ring 120 can include the protrusions. In some embodiments, a ball bearing could be used that when reaching particular locations is stopped from further rotation.

In some embodiments, there may be one or more resistance elements along one of the first ring 118 or the second ring 120 that can provide tactical feedback to a user. For example, these can be placed at periodic locations about the rings that provide the user feedback of reaching set amounts of rotation (e.g., 30°, 45°, 60°, or the like).

The terminology used herein is intended to describe embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

1. A plug assembly comprising:
a housing configured to be installed to a first surface of a body; and
a power outlet configured to receive an electrical plug;
wherein the power outlet is configured to be removably stored within the housing;
wherein in a stored configuration, the power outlet is at least partially stored within the housing;
wherein in a deployed configuration, the power outlet is exposed from the housing and extends beyond a second surface of the body;
wherein the power outlet is configured to be rotatable about a longitudinal axis of the housing when the power outlet is in the deployed configuration.

2. The plug assembly of claim 1, wherein in the stored configuration, the power outlet is configured to be electrically isolated from a power source.

3. The plug assembly of claim 1, wherein the power outlet comprises a ground fault circuit interrupter.

4. The plug assembly of claim 1, wherein the power outlet comprises one or more low voltage accessory inputs configured to receive a low voltage plug.

5. The plug assembly of claim 1, wherein the housing is configured to be sealed to prevent ingress of water.

6. The plug assembly of claim 1, wherein the first surface of the body is an underside of the body.

7. The plug assembly of claim 6, wherein the first surface is a countertop surface.

8. The plug assembly of claim 6, wherein the first surface is a desktop surface, a tabletop surface, or a furniture surface.

9. The plug assembly of claim 6, wherein in the deployed configuration, the power outlet is configured to be disposed above the second surface of the body.

10. The plug assembly of claim 1, wherein the power outlet comprises a three-prong opening.

11. The plug assembly of claim 10, wherein the power outlet comprises a universal serial bus (USB) port.

12. The plug assembly of claim 1, wherein the power outlet is configured to be rotatable by less than 360°, and wherein the power outlet is configured to be rotatable by at least 30°.

13. The plug assembly of claim 1, further comprising:
a first ring, wherein the first ring includes a protrusion; and
a second ring, wherein the second ring has a channel, wherein the channel includes a first end and a second end;
wherein the first end and the second end limit an amount of rotation of the power outlet.

14. The plug assembly of claim 13, wherein the first ring or the second ring is configured to provide tactical feedback during rotation in response to a set amount of rotation.

15. A plug assembly comprising:
a housing configured to be installed to a bottom surface of a countertop; and
a power outlet configured to receive an electrical plug;
wherein the power outlet is configured to be removably stored within the housing;
wherein in a stored configuration, the power outlet is at least partially stored within the housing;
wherein in a deployed configuration, the power outlet is exposed from the housing and extends beyond a top surface of the countertop;
wherein the power outlet is configured to be rotatable about a longitudinal axis of the housing when the power outlet is in the deployed configuration.

16. The plug assembly of claim 15, wherein the power outlet comprises a ground fault circuit interrupter.

17. The plug assembly of claim 15, wherein the power outlet comprises one or more low voltage accessory inputs configured to receive a low voltage plug.

18. The plug assembly of claim 15, wherein the plug assembly comprises a cap; wherein the cap comprises a wireless power charger configured to inductively charge an electronic device placed on the cap.

19. The plug assembly of claim 15, wherein the power outlet is configured to be rotatable by less than 360°, and wherein the power outlet is configured to be rotatable by at least 30°.

20. The plug assembly of claim 15, further comprising:
a first ring, wherein the first ring includes a protrusion; and
a second ring, wherein the second ring has a channel, wherein the channel includes a first end and a second end;
wherein the first end and the second end limit an amount of rotation of the power outlet.
